(19) United States
(12) Patent Application Publication
(10) Pub. No.: US 2015/0302476 A1
(43) Pub. Date: Oct. 22, 2015

(54) METHOD AND APPARATUS FOR SCREENING PROMOTION KEYWORDS

(71) Applicant: Alibaba Group Holding Limited, Grand Cayman (KY)

(72) Inventors: Kaiming Huang, Hangzhou (CN); Kewen Wu, Hangzhou (CN); Peng Huang, Hangzhou (CN); Bo Li, Hangzhou (CN); Feng Lin, Hangzhou (CN)

(21) Appl. No.: 14/692,586

(22) Filed: Apr. 21, 2015

(30) Foreign Application Priority Data
Apr. 22, 2014 (CN) 201410161778.0

(51) Int. Cl. G06Q 30/02

(52) U.S. Cl. CPC G06Q 30/0256

(57) ABSTRACT

Candidate promotion keywords are selected. Features of the candidate promotion keywords are extracted. The features include at least one of a search engine feature, an effect feature of non-directed traffic, and a text feature. The features of the candidate promotion keywords are used as input data of a pre-established keyword screening model, and superior promotion keywords are obtained according to a prediction result of the keyword screening model.

### CROSS REFERENCE TO RELATED PATENT APPLICATION

This application claims foreign priority to Chinese Patent Application No. 201410161778.0 filed on 22 Apr. 2014, entitled “Method and Apparatus for Screening Promotion Keywords,” which is hereby incorporated by reference in its entirety.

### TECHNICAL FIELD

The present disclosure relates to the field of computer network technology, and more particularly, to a method and apparatus of screening promotion keywords.

### BACKGROUND

Search engine promotion is broadly used by merchants, especially, e-commerce type websites, in recent years because of its immediate impact. Normally, the search engine promotion is conducted by placing promotion keywords. That is, when a user searches a keyword in a search engine, promotion information of a merchant that places the keyword may be displayed. Therefore, with respect to the merchant, an important step in the search engine promotion is screening keywords. A superior keyword may increase on-line traffic, which is needed in the development of merchant websites, and meet the expected placement requirement of the merchant website.

Currently, a commonly-used method of screening promotion keywords is mainly to extract effect data in a promotion system of a website, such as traffic, clicks, a conversion rate, and to set different thresholds for different effect data according to operation experiences to screen keywords which meet conditions to be used as superior keywords. Although such a method is easy to operate, a determination of the thresholds for the screening has to rely on the operation experiences, and such screening method based on a fixed threshold has to follow certain rules and may only screen existing effects in the promotion system based on the keywords. Thus, the traditional method is not suitable for search engine promotion and has low accuracy.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides example methods and apparatuses for screening promotion keywords to improve an accuracy of screening promotion keywords at a search engine promotion.

The present disclosure provides an example method for screening promotion keywords. Candidate promotion keywords are selected. Features of the candidate promotion keywords are extracted. The features include at least one of a search engine feature, an effect feature of non-directed traffic, and a text feature. The features of the candidate promotion keywords are used as input data of a pre-established keyword screening model, and superior promotion keywords are obtained according to a prediction result of the keyword screening model.

### DRAWINGS

FIG. 1 is a flow chart of an example method for establishing a keyword screening model according to the present disclosure.

FIG. 2 is a flow chart of an example method for predicting superior keywords according to the present disclosure.

FIG. 3 is a structural diagram of an example apparatus for screening promotion keywords according to the present disclosure.

### DETAILED DESCRIPTION

To make the objectives, technical solutions and advantages of the present disclosure clear, the present disclosure is described in detail by reference to the accompanying FIGs and example embodiments.

The techniques of the present disclosure use promotion keywords that have been placed into a search engine as training samples, and, after at least one of a search engine feature, an effect feature of non-directed traffic and a text feature of each of the promotion keywords in the training samples are extracted, establish a keyword screening model by using these training samples. The techniques of the present disclosure use the established keyword screening model to predict to-be-placed candidate promotion keywords, and screen superior promotion keywords from candidate promotion keywords according to the prediction result.

For example, the operation of selecting the candidate promotion keywords may include the following. The candidate promotion keywords are selected by using search keywords of a merchant website and/or expansion words of promotion keywords that have been placed into a search engine.

For example, the features may further include a bid feature.

Between a lowest bid and a highest bid, bid features of the candidate promotion keywords are constructed according to a preset bid interval respectively.

For example, the example method may further include determining a suggested bid price of a superior promotion keyword. The detailed operations may include the following.

The bid features of the superior promotion keyword predicted by the keyword screening model are combined and the highest bid is used as the suggested bid price of the superior promotion keyword.

For example, the example method may further include applying at least one of the following filtering processing to the obtained superior promotion keywords:

Promotion keywords that have been placed into the search engine are removed from the obtained superior promotion keywords. Illegal keywords are removed from the obtained superior promotion keywords according to a prohibited word black list of a merchant website and/or a prohibited word black list of the search engine.

For example, the establishment of the keyword screening model may include using data of the promotion keywords that have been placed into the search engine as training samples. Data of the promotion keywords is used to determine return on investment of the promotion keywords respectively, and the training samples are labeled according to the return on investment for the each of the promotion keywords. Features of each of the promotion keywords are extracted from the training samples. Such features are consistent with the extracted features of the candidate promotion keywords. The keyword screening model is obtained by using the extracted features and the labeled training samples.

For example, the data of the promotion keywords is used to determine return on investment of the promotion keywords respectively according to the following operations.

A ratio of a traffic introduced into the merchant website by the promotion keyword through the search engine to a cost of the investment of the merchant for the promotion keyword is used as the return on investment for the promotion keyword.

Alternatively, a ratio of advertising income introduced into the merchant by the promotion keyword through the search engine to a cost of the investment of the merchant for the promotion keyword is used as the return on investment for the promotion keyword.

Alternatively, a ratio of a trade volume introduced into the merchant by the promotion keyword through the search engine to a cost of the investment of the merchant for the promotion keyword is used as the return on investment for the promotion keyword.

For example, the labeling of the training samples according to the return on investment for each of the promotion keywords may include the following operations.

If the return on investment for a promotion keyword is greater than or equal to a preset first threshold, the promotion keyword is labeled as a superior promotion keyword.

If the return on investment for a promotion keyword is less than a preset second threshold, the promotion keyword is labeled as an inferior promotion keyword. The first threshold is greater than or equal to the second threshold.

For example, if the first threshold is greater than the second threshold, the labeling of the training samples according to the return on investment for each of the promotion keywords may further include the following operations.

If the return on investment for a promotion keyword is greater than or equal to the second threshold and is less than the first threshold, the promotion keyword is labeled as a medium promotion keyword.

For example, the search engine feature of the promotion keyword includes a search volume and/or popular rate information of the promotion keyword in the search engine.

The effect feature of non-directed traffic of the promotion keyword includes at least one of a search volume, a page view, a click rate, and a trade volume of the promotion keyword at the merchant website.

The text feature of the promotion keyword includes at least one of a word feature, a semantic feature, and an industry feature of the promotion keyword.

The word feature includes at least one of a smallest word segmentation unit, a quantity of the smallest word segmentation units, and a character length of the promotion keyword. The semantic feature includes at least one of a head word, a product word, and a brand word included in the promotion keyword. The industry feature refers to an industry category to which the promotion keyword belongs.

The present disclosure further provides an example apparatus for screening promotion keywords. The apparatus may include the following units.

A keyword selection unit selects candidate promotion keywords. A feature extraction unit extracts features of the candidate promotion keywords. The features include at least one of a search engine feature, an effect feature of non-directed traffic, and a text feature. A keyword screening unit uses the features of the candidate promotion keywords as input data of a pre-established keyword screening model, and obtains superior promotion keywords according to a prediction result of the keyword screening model.

For example, the keyword selection unit may select the candidate promotion keywords by using the search keywords of a merchant website and/or expansion words of the promotion keywords that have been placed into a search engine.

For example, the features further include a bid feature. The feature extraction unit may, between the lowest bid and the highest bid, construct bid features of the candidate promotion keywords according to a preset bid interval respectively.

For example, the apparatus may further include a bid price suggesting unit that determines suggested bid prices of the superior promotion keywords, which combines the bid features of the superior promotion keywords predicted by the keyword screening model and uses the highest bids as the suggested bid prices of the superior promotion keywords.

For example, the apparatus may further include a keyword filtering unit that perform at least one of the following filtering processing on the superior promotion keywords obtained by the keyword screening unit.

Promotion keywords that have been placed into the search engine are removed from the obtained superior promotion keywords. Illegal keywords are removed from the obtained superior promotion keywords according to a prohibited word black list of a merchant website and/or a prohibited word black list of a search engine.

For example, the apparatus may further include a screening model establishing unit. The screening model establishing unit may specifically include the following sub-units.

A sample determination sub-unit uses data of the promotion keywords that have been placed into the search engine as training samples. A sample labeling sub-unit determines, by using the data of the promotion keywords, the return on investment for each of the promotion keywords, and labels the training samples according to the return on investment for the each of the promotion keywords. A feature extraction sub-unit extracts features of the promotion keywords in the training samples. The features are consistent with the extracted features of the candidate promotion keywords. A model training sub-unit trains a classification model by using the extracted features and the labeled training samples to obtain the keyword screening model.

For example, the sample labeling sub-unit may determine the return on investment for each of the promotion keywords by using any of the following methods.

A ratio of a traffic introduced into the merchant website by the promotion keyword through the search engine to a cost of the investment of the merchant for the promotion keyword is used as the return on investment for the promotion keyword.

Alternatively, a ratio of advertising income introduced into the merchant by the promotion keyword through the search engine to a cost of the investment of the merchant for the promotion keyword is used as the return on investment for the promotion keyword.

Alternatively, a ratio of a trade volume introduced into the merchant by the promotion keyword through the search engine to a cost of the investment of the merchant for the promotion keyword is used as the return on investment for the promotion keyword.

For example, the sample labeling sub-unit may label the training samples by using the following operations.

If the return on investment for a promotion keyword is greater than or equal to a preset first threshold, the promotion keyword is labeled as a superior promotion keyword.

If the return on investment for a promotion keyword is less than a preset second threshold, the promotion keyword is labeled as an inferior promotion keyword. The first threshold is greater than or equal to the second threshold.

For example, if the first threshold is greater than the second threshold, the sample labeling sub-unit may label the training samples by using the following operations.

If the return on investment for a promotion keyword is greater than or equal to the second threshold and is less than the first threshold, the promotion keyword is labeled as a medium promotion keyword.

For example, the search engine feature of the promotion keyword includes a search volume and/or popular rate information of the promotion keyword in the search engine.

The effect feature of non-directed traffic of the promotion keyword includes at least one of a search volume, a page view, a click rate, and a trade volume of the promotion keyword at the merchant website.

The text feature of the promotion keyword includes at least one of a word feature, a semantic feature, and an industry feature of the promotion keyword.

The word feature includes at least one of a smallest word segmentation unit, a quantity of the smallest word segmentation units, and a character length of the promotion keyword. The semantic feature includes at least one of a head word, a product word, and a brand word included in the promotion keyword. The industry feature refers to an industry category to which the promotion keyword belongs.

As shown from the above technical solutions that, the present disclosure, after the features of the candidate promotion keywords are extracted, predict the superior promotion keywords by using a trained keyword screening model instead of the conventional screening mode that merely relies on a fixed threshold and has strong regularity. The present disclosure is also capable of predicting keywords that have no effect yet in the promotion system, thereby improving the accuracy and recall rate of the screening of the superior promotion keywords.

In other words, the present disclosure mainly includes two processes: a process of establishing a keyword screening model and a process of predicting superior keywords. The process of establishing the keyword screening model may be executed in advance. However, along with the increase of promotion keywords placed into the search engine, the process of establishing a keyword screening model may be executed periodically to gradually optimize the keyword screening model. The prediction of superior keywords is performed based on the established keyword screening model. The two processes are described in detail below respectively through the example embodiments.

An example process for establishing a keyword screening model is described as follows.

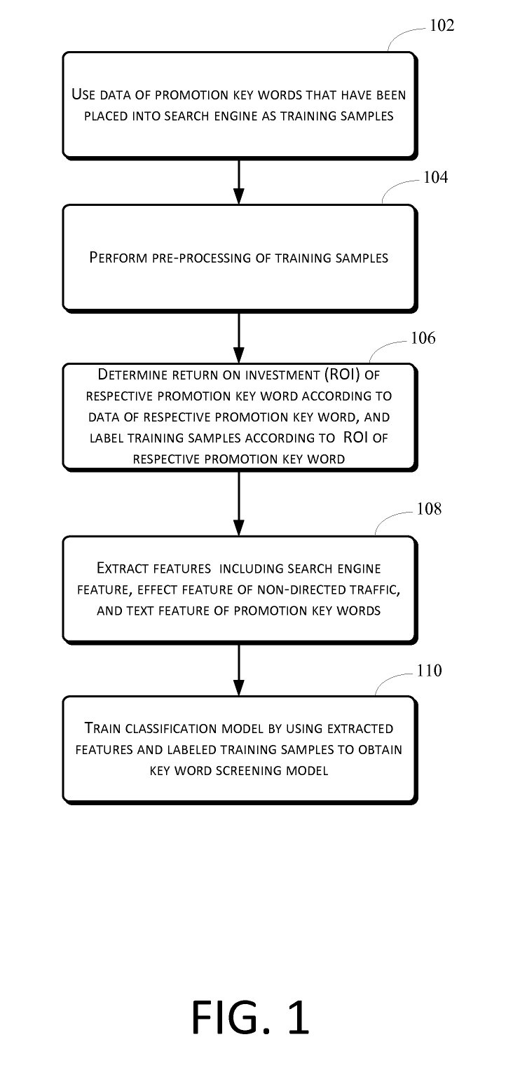

FIG. 1 is a flow chart of an example method for establishing a keyword screening model according to an example embodiment of the present disclosure. As shown in FIG. 1, the process for establishing the keyword screening model may include the following operations.

At 102, data of promotion keywords that have been placed into a search engine is used as training samples.

Since the promotion keywords that have been placed into the search engine already have certain effect data and consumption data, the training samples for establishing a keyword screening model come from the data of the promotion keywords that have been placed into the search engine. The data may include consumption data and effect data.

The consumption data reflects the investment cost of the keyword promotion in the search engine, such as exposure, click rate, and consumption sum. Since the exposure and click rate in the search engine affect the promotion cost of a merchant, such data belong to the consumption data.

The effect data reflects the promotion income introduced into the merchant website by the keyword through the search engine, such as page view, click rate, trade volume, and search volume of the keyword at the merchant website. Since a user will be taken to the merchant website after he/she clicks the keyword in the search engine, which will translate into the behaviors of the user at the merchant website such as browsing, clicking, searching and purchasing, and those behaviors will bring advertising income or order income to the merchant website, such data belong to the effect data.

Certainly, the data of the promotion keywords may further include some other keyword attribute data, such as a placement time, a placement region, a placement language, and bid information.

At 104, a pre-processing of the training samples is performed.

The pre-processing performed on the training samples may include, but not limited to, the following two types:

A first type is to delete abnormal data. In order to prevent abnormal data from affecting the accuracy of the keyword screening model, the abnormal keywords in the training samples may be deleted directly, which include, but are not limited to, the data of keywords that have data loss or data value exceeding a normal range. For example, if a certain keyword does not have effect data, data of such keyword may be deleted. For another example, if a click rate of a certain keyword in the search engine is a negative number or a non-numerical amount, data of such keyword may be deleted.

A second type is to, in accordance with the placement requirement, select the sample data according to attributes of keywords. For example, if the placement requirement is to place keywords in different regions, the sample data may be selected in the mode “keyword +region”, that is, the data of keywords of a corresponding placement region is selected as the sample data. If the placement requirement is to place the keywords in different languages, the sample data may be selected in the mode “keyword +language”, that is, the data of keywords of a corresponding placement language is selected as the sample data.

In addition, if the feature extracted during the establishment of the keyword screening model includes a bid feature, a third type of pre-processing may also be performed. The same bid information of the same keyword at different placement times are combined. For example, the bid information corresponding to a certain keyword at placement time t1, t2, t3, t4, t5, and t6 is 0.1, 0.1, 0.1, 0.2, 0.2, and 0.3 respectively. The same bid information may be combined into one piece of data, that is, merely three bid information, 0.1, 0.2, and 0.3, are retained.

The pre-processing performed on the sample data in this step helps accelerate the model establishment and further improves the accuracy of the established model, which is an optional step.

At 106, a return on investment (ROI) of each of the promotion keywords is determined according to the data of the promotion keywords, and the training samples are labeled according to the ROIs of each of the promotion keywords.

The techniques of the present disclosure may label positive and negative samples for training the keyword screening model. The positive samples are superior promotion keywords, and during the labeling of the training samples, the superior promotion keywords may be determined according to the ROIs for the keywords. According to different placement targets, the ROI may be determined in different modes.

A first mode focuses on the traffic introduced in the merchant website, and therefore, a keyword satisfying that the directed traffic per unit cost is greater than a preset threshold is a superior promotion keyword.

That is,

$$R O I = \frac{P V}{Cost} ,$$

wherein PV is the traffic introduced into the merchant website by the keyword through the search engine, and Cost is the cost of the investment of the merchant for the keyword.

A second mode focuses on the advertising income, and therefore, a keyword satisfying that the introduced advertising income per unit cost is greater than a preset threshold is a superior promotion keyword.

That is,

$$R O I = \frac{Income}{Cost} ,$$

wherein Income is the advertising income introduced into the merchant by the keyword through the search engine, and Cost is the cost of the investment of the merchant for the keyword.

A third mode focuses on the introduced trade volume, and therefore, a keyword satisfying that the introduced trade volume per unit cost is greater than a preset threshold is a superior promotion keyword.

That is

$$R O I = \frac{Volume}{Cost} ,$$

wherein Volume is the trade volume introduced into the merchant by the keyword through the search engine, and Cost is the cost of the investment of the merchant for the keyword.

For a certain keyword, if ROI≧ROIₜₕ₁ (a first threshold of ROI), the keyword data of such keyword is labeled as a positive sample, that is, the keyword is determined as a superior promotion keyword. If ROI<ROIₜₕ₂ (a second threshold of ROI), the keyword data of the keyword is labeled as a negative sample, that is, the keyword is determined as an inferior promotion keyword. ROIₜₕ₁ and ROIₜₕ₂ are preset thresholds, and ROIₜₕ₁≧ROIₜₕ₂. Furthermore, if ROIₜₕ₁>ROIₜₕ₂ are used, there will be another labeling result, that is, ROIₜₕ₂ ROI<ROIₜₕ₁, and in this case, the keyword will be labeled as a medium promotion keyword.

For example, when the third mode as described above is adopted, ROIₜₕ₁ may be 1, and ROIₜₕ₂ may be 0.5, that is, a keyword whose introduced trade volume per unit cost being greater than or equal to 1 is labeled as a superior promotion keyword, a keyword whose introduced trade volume per unit cost being less than 0.5 is labeled as an inferior promotion keyword, and a keyword whose introduced trade volume per unit cost is greater than or equal to 0.5 and less than 1 is labeled as a medium promotion keyword.

During the sample labeling, there may exist a problem of insufficient data as some promotion keywords that have been placed into the search engine may merely obtain little traffic from the search engine, and in this case, the labeling result is incredible. Here, the number of the incredible samples may be reduced by setting a credibility threshold. In an example embodiment of the present disclosure, the credibility threshold may be set as that the number of clicks obtained from the search engine within 3 months is greater than or equal to 10, that is, if the number of clicks obtained by a certain promotion keyword from the search engine within 3 months is less than 10, the promotion keyword is deleted from the sample data.

At 108, one or more features of each of the promotion keywords in the training samples are extracted. The features may include a search engine feature, an effect feature of non-directed traffic, and a text feature.

Since the promotion keywords that need to be predicted may not be placed into the search engine yet, there is no effect feature of the consumption data and directed traffic (the so-called directed traffic is a traffic introduced into the merchant website from the search engine), and thus other features need to be extracted. In the present disclosure, extractable features may include at least one of the search engine feature, the effect feature of non-directed traffic, and the text feature. The extracted features may further include a bid feature.

The search engine features may be a search volume and/or popular rate information of the promotion keyword in the search engine, and such feature may be obtained by using relevant tools of the search engine, for example, such as GoogleTM trends or GoogleTM keyword tools.

The effect feature of non-directed traffic refers to other effect features of the promotion keyword other than search engine's directed traffic, which for example, includes at least one of a search volume, a page view, a click rate, and a trade volume of the promotion keyword at the merchant website.

The text feature refers to a feature reflected by a text attribute of the promotion keyword, and may include at least one of a word feature, a semantic feature, and an industry feature.

The word feature refers to at least one of a smallest word segmentation unit, a quantity of the smallest word segmentation units, and a character length included in the promotion keyword. The smallest word segmentation unit may be determined by a word segmentation tool in a natural language processing tool, for example, in terms of “ [symbol] [symbol] ” in Chinese (“apple music player” in English), its smallest word segmentation units are “ [symbol] ”, “ [symbol] ” and “ [symbol] (player)” respectively. With respect to English keywords, its smallest word segmentation units are generally divided according to the spaces between words. For example, in terms of “apple mp3 player”, its smallest word segmentation units are “apple”, “mp3,” and “player” respectively.

The semantic feature refers to a feature such as a head word, a product word or a brand word included in the promotion keywords, which may be extracted by using the natural language processing tool. For example, for the keywords “ [symbol] ” (apple music player)”, the head word extracted by using the natural language processing tool is “ [symbol] (player)”, the product word is “ [symbol] (music player)”, and the brand word is “ [symbol] (apple)”.

The industry feature refers to an industry category to which the promotion keywords belong, and the industry category to which the keywords belong may be predicted by using a category prediction tool. For example, “ [symbol] (apple music player)” is predicted by using the category prediction tool as a digital category.

The bid feature refers to bid information of the promotion keywords in the search engine promotion, which directly affects the investment cost of the merchant, thereby impacting whether the promotion keywords are superior promotion keywords.

At 110, a classification model is trained by using the extracted features and the labeled training samples to obtain the keyword screening model.

The classification model used in the example embodiment of the present disclosure may be, but is not limited to, a decision tree, a support vector machine (SVM) classifier, and a logistic classifier. The training process of the classification model is a mature technology, and will not be described in detail herein. After the classification model is trained by using the extracted feature and the labeled training samples, the keyword screening model is obtained.

The prediction process of the superior keywords is as follows.

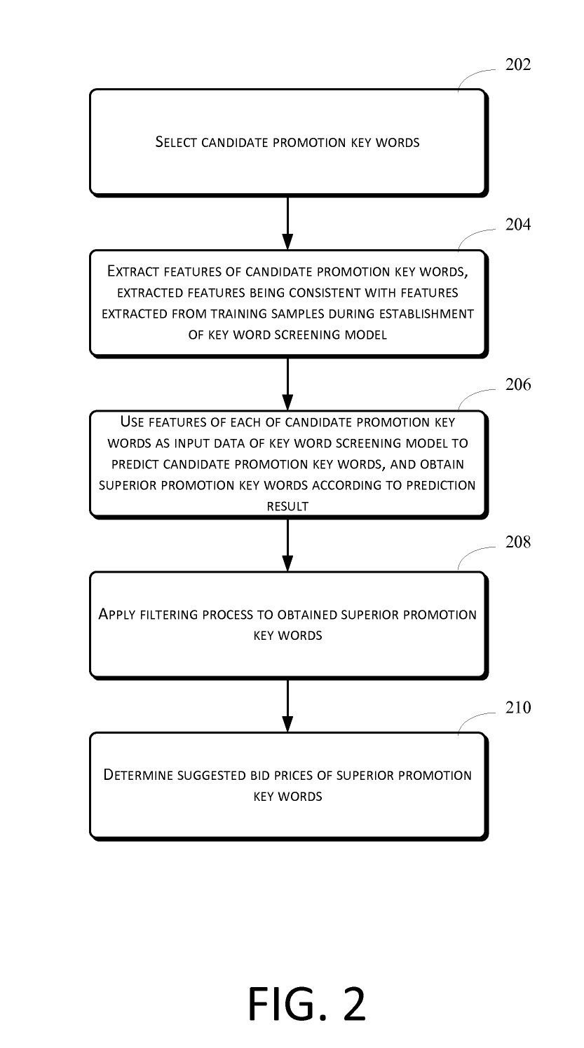

FIG. 2 is a flow chart of an example method for predicting superior keywords according to an example embodiment of the present disclosure. As shown in FIG. 2, the process of predicting the superior keywords mainly includes the following operations.

At 202, candidate promotion keywords are selected.

In the example embodiment of the present disclosure, the candidate promotion keywords may be obtained from two sources: search keywords of a merchant website and/or expansion words of promotion keywords that have been placed into the search engine.

The search keywords of the merchant website are keywords used by users for searching at the merchant website, and the keywords reflect, to a certain degree, the degree of interest of the users in the services or commodities provided by the merchant. By selecting candidate promotion keywords from these search keywords, the probability of bringing in a conversion effect for the merchant is high. The internal search keywords of the users in the merchant website within a certain period of time and the conversion effect data of the keywords in the merchant website may be obtained from search logs of the website. The conversion effect data includes, for example, a search volume of the search keywords, and a page view, a click rate, a trade volume and the like caused by the search keywords. Here, search keywords having poor website conversion effects may be excluded by setting a threshold for the conversion effect data, while the remaining search keywords are used as candidate promotion keywords. Alternatively, search keywords having good website conversion effects are selected by setting a threshold for the conversion effect data, and the selected search keywords are used as candidate promotion keywords.

With respect to the promotion keywords that have been placed into the search engine, the promotion keywords having good effects in the promotion keywords that have been placed into the search engine may be expanded by using an expansion tool, and the obtained expansion words are added into the candidate promotion keywords. The keywords expanded by the word expansion tool are mainly synonyms or translated words. The synonym is easy to understand, and the translated word refers to a corresponding expression of a word in another commonly used language. For example, a common translated word of the brand “ [symbol] ” in Chinese is “apple” in English.

At 204, features of the candidate promotion keywords are extracted. The extracted features are consistent with the features extracted from training samples during the establishment of a keyword screening model.

Since the keyword screening is performed by using the keyword screening model, in this step, when the features are extracted from the candidate promotion keywords, the features need to be consistent with the features extracted during the establishment of the keyword screening model. That is, according to what kind of features are extracted at 108 shown in FIG. 1, the same kinds of features need to be extracted for the candidate promotion keywords in this step as well. If the features extracted at 108 include the search engine feature, the effect feature of non-directed traffic, and the text feature, the features of the candidate promotion keywords extracted in this step also include the search engine feature, the effect feature of non-directed traffic, and the text feature. As the extraction methods are same or similar, details are not described herein.

If the bid feature is further extracted during the establishment of the keyword screening model, the bid features also need to be extracted for the candidate promotion keywords in this step. However, since the candidate promotion keywords may not be placed into the search engine yet, there may not be bid feature. In this step, it is necessary to construct bid features for the candidate promotion keywords. When the bid features are constructed, the bid features may be constructed between the lowest bid and the highest bid according to a preset bid interval respectively. For example, with respect to the candidate promotion keywords “4-core mobile phone”, “4-core mobile phone: 0.1”, “4-core mobile phone: 0.2”, “4-core mobile phone: 0.3”, . . . , “4-core mobile phone: 1.0” are constructed, wherein 0.1 (USD) is the lowest bid, 1.0 (USD) is the highest bid, and ten pieces of input data of the keyword screening model, that is, ten bid features, are constructed according to a bid interval of 0.1 (USD).

At 206, the features of each of the candidate promotion keywords are used as input data of the keyword screening model to predict the candidate promotion keywords, and superior promotion keywords are obtained according to a prediction result.

In fact, the keyword screening model is a classification model, and therefore, the process that features of each of the candidate promotion keywords are used as the input data of the keyword screening model for prediction is actually a classification process of the classification model. The candidate promotion keywords are at least classified into superior promotion keywords and inferior promotion keywords, and may also be classified into medium promotion keywords. For example, the number of classification results depends on the number of labeling results when the training samples are labeled during the establishment of the keyword screening model.

At 208, a filtering process is applied to the obtained superior promotion keywords.

This step is a further processing for optimizing the obtained superior promotion keywords, and is an optional step. The filtering process in this step may include, but is not limited to, the following operation.

A first filtering process is to remove promotion keywords that have been placed into the search engine from the obtained superior promotion keywords.

A second filtering process is to remove illegal keywords from the obtained superior promotion keywords. The illegal keywords are determined according to a prohibited word black list of a merchant website and/or a prohibited word black list of a search engine.

At 210, suggested bid prices of the superior promotion keywords are determined.

Also, this step is an optional step of the present disclosure. If the features extracted from the keyword screening model include the bid features, the bid features of the superior promotion keywords output by the keyword screening model may be combined, and the highest bid therein may be used as a suggested bid price.

For example, assuming that after the bid features of the superior promotion keywords “4-core mobile phone” output by the keyword screening model are combined, an obtained set is {0.1, 0.2, 0.3, 0.4} and a suggested bid price Bidprice_{suggestion} is:

Bidprice_{suggestion}=max({0.1, 0.2, 0.3, 0.4})=0.4 (USD),

That is, when the suggested bid price is 0.4 (USD), the superior promotion keywords may obtain a traffic as large as possible.

If the features extracted from the keyword screening model do not include the bid features, the suggested bid prices may be determined according to operation experience or according to the effect data of the superior promotion keywords.

The method provided in the present disclosure is described in detail in the above, and an apparatus provided in the present disclosure is described in detail through an example embodiment as follows.

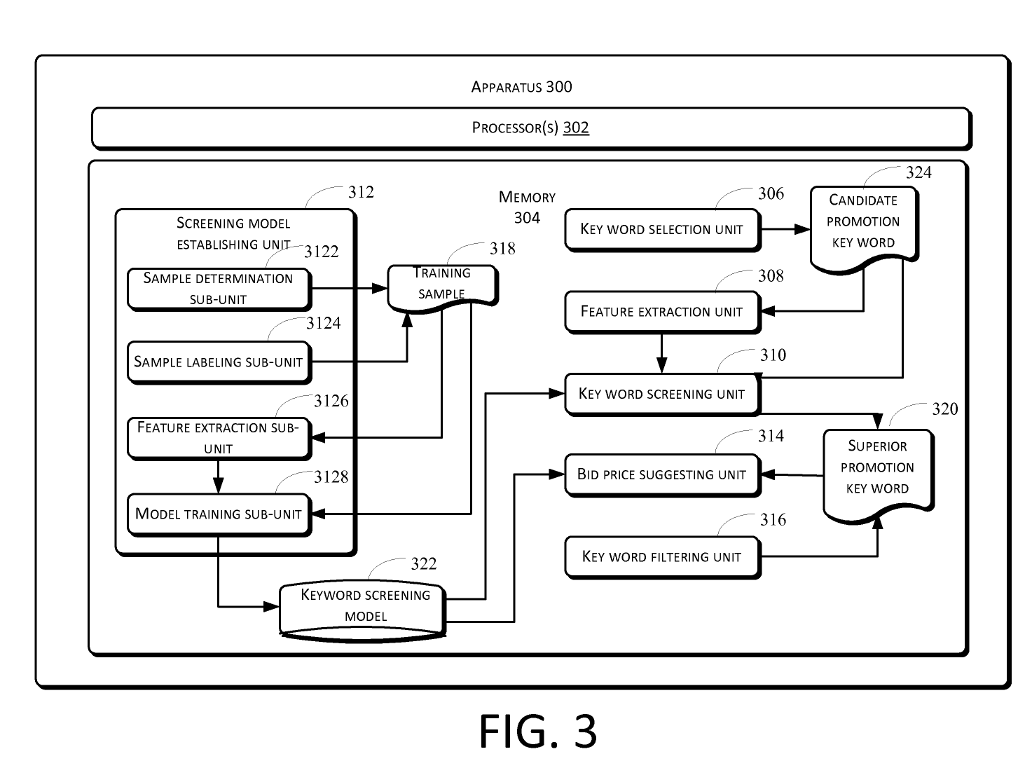

FIG. 3 is a structural diagram of an example apparatus for screening promotion keywords according to present disclosure. As shown in FIG. 3, the apparatus 300 may include one or more processor(s) or data processing unit(s) 302 and memory 304. The memory 304 is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

The memory 304 may store therein a plurality of modules or units including a keyword selection unit 306, a feature extraction unit 308, and a keyword screening unit 310, and may further include a screening model establishing unit 312, a bid price suggesting unit 314, and a keyword filtering unit 316.

The apparatus provided in the present disclosure performs the screening of superior promotion keywords by using a pre-established keyword screening model. For the purpose of illustration, the structure of the screening model establishing unit 312 is firstly described in detail. The screening model establishing unit 312 establishes a keyword screening model in advance, and, along with the increase of promotion keywords placed into the search engine, the screening model establishing unit 312 may periodically perform the process of establishing the keyword screening model to optimize the keyword screening model.

For example, the screening model establishing unit 312 may include: a sample determination sub-unit 3122, a sample labeling sub-unit 3124, a feature extraction sub-unit 3126, and a model training sub-unit 3128.

First, the sample determination sub-unit 3122 uses data of promotion keywords that have been placed into the search engine as training samples 318. The data of the promotion keywords include consumption data and effect data. The consumption data reflects the investment cost of the promotion of keywords in the search engine, such as an exposure, a click rate, and a consumption sum of the keywords in the search engine. Since the exposure and click rate in the search engine affect the promotion cost of the merchant, those data belong to the consumption data. The effect data reflects promotion income introduced into the merchant website by the keyword through the search engine, such as the page view, click rate, trading volume and search volume of the keyword at the merchant website. Since a user will be directed to the merchant website after clicking the keyword in the search engine, which will translate into the behaviors of the user at the merchant website such as browsing, clicking, searching and purchasing, and those behaviors bring in advertising income or order income for the merchant website. Thus such data belong to the effect data. Certainly, the data of the promotion keywords may further include some other keyword attribute data, such as a placement time, a placement region, a placement language, and bid information.

Further, after the sample determination sub-unit 3122 determines the training samples 318, the following pre-processing may be applied to the training samples 318, which includes, but is not limited to, the following operations.

A first operation: abnormal data is deleted. In order to prevent abnormal data from affecting correctness of the keyword screening model, abnormal keywords in the training samples 318 may be deleted directly, which includes, but not limited to: data of keywords that have data loss or data value exceeding a normal range is deleted. For example, if a certain keyword does not have effect data, data of the keyword may be deleted. For another example, if a click rate of a certain keyword in the search engine is a negative number or is a non-numerical amount, data of the keyword may be deleted.

A second operation: based on the placement requirement, the sample data is selected according to the attributes of keywords. For example, if the placement requirement is to put keywords in different regions, the sample data may be selected in the mode “keyword +region”, that is, data of keywords of a corresponding placement region is selected as the sample data. If the placement requirement is to put keywords in different languages, the sample data may be selected in the mode “keyword +language”, that is, the data of keywords of a corresponding placement language is selected as the sample data.

In addition, if the feature extracted during establishment of the keyword screening model includes a bid feature, a third type of pre-processing may also be performed: the same bid information of the same keyword at different placement times is combined.

Then, the sample labeling sub-unit 3124 determines ROIs of the promotion keywords according to the data of the promotion keywords, and labels the training samples 318 according to the ROIs of each of the promotion keywords.

For example, the sample labeling sub-unit 3124 may determine the ROIs of the promotion keywords by any of the following operations.

A first method focuses on traffic introduced in the merchant website, and therefore, a keyword satisfying that directed traffic per unit cost is greater than a preset threshold is a superior promotion keyword.

That is,

$$R O I = \frac{P V}{Cost} ,$$

wherein PV is traffic introduced into the merchant website by the keyword through the search engine, and Cost is the cost of the investment of the merchant for the keyword.

A second method focuses on advertising income, and therefore, a keyword satisfying that introduced advertising income per unit cost is greater than a threshold hold is a superior promotion keyword.

That is,

$$R O I = \frac{Income}{Cost} ,$$

wherein Income is the advertising income introduced into the merchant by the keyword through the search engine, and Cost is the cost of the investment of the merchant for the keyword.

A third method focuses on introduced trading volume, and therefore, a keyword satisfying that introduced trading volume per unit cost is greater than a preset threshold is a superior promotion keyword.

That is,

$$R O I = \frac{Volume}{Cost} ,$$

wherein Volume is trading volume introduced into the merchant by the keyword through the search engine, and Cost is the cost of the investment of the merchant for the keyword.

For the promotion keywords, if ROI ROIₜₕ₁, the sample labeling sub-unit 3124 labels the promotion keywords as superior promotion keywords 320. With respect the promotion keywords, if ROI<ROIₜₕ₂, the sample labeling sub-unit 3124 labels the promotion keywords as inferior promotion keywords; wherein ROIₜₕ₁≦ROIₜₕ₂.

If ROIₜₕ₁>ROIₜₕ₂, the sample labeling sub-unit 3124 further performs labeling on the training samples 318 as follows: if the ROI of the promotion keywords is in a case of ROIₜₕ₂≦ROI<ROIₜₕ₁, the promotion keywords are labeled as medium promotion keywords.

The feature extraction sub-unit 3126 is responsible for extracting the features of each of the promotion keywords in the training samples 318. Since promotion keywords that need to be predicted may not be placed yet, there exists no consumption data and directed traffic. Thus other features need to be extracted. In the present disclosure, extractable features may include at least one of the search engine feature, the effect feature of non-directed traffic, and the text feature, and may further include a bid feature.

The search engine feature may be a search volume and/or popular rate information of the promotion keyword in the search engine, and the feature may be obtained by using relevant tools of the search engine, for example, obtained by using GoogleTM trends or GoogleTM keyword tools.

The effect feature of non-directed traffic refers to other effect features of the promotion keyword other than search engine directed traffic, for example, at least one of a search volume, a page view, a click rate, and a trade volume of the promotion keyword at the merchant website.

The text feature refers to a feature reflected by a text attribute of the promotion keyword, and may include at least one of a word feature, a semantic feature, and an industry feature.

The word feature refers to at least one of smallest word segmentation units, the quantity of the smallest word segmentation units, and a character length included in the promotion keyword.

The semantic feature refers to a feature such as a head word, a product word or a brand word included in the promotion keywords, which may be extracted by using the natural language processing tool. For example, for the keywords “ [symbol] (apple music player)”, the head word extracted by using the natural language processing tool is “ [symbol] (player)”, the product word is “ [symbol] (music player)”, and the brand word is “ [symbol] (apple)”.

The industry feature refers to an industry category to which the promotion keywords belong, and the industry category to which the keywords belong may be predicted by using a category prediction tool. For example, “ [symbol] (apple music player)” is predicted by using the category prediction tool as a digital category.

The bid feature refers to bid information of the promotion keywords in the search engine promotion, which affects investment cost of the merchant directly.

Finally, the model training sub-unit 3128 trains a classification model by using the extracted feature and the labeled training samples to obtain the keyword screening model 322. The classification model used in the embodiment of the present disclosure may be, but not limited to: a decision tree, a support vector machine (SVM) classifier, and a Logistic classifier. The training process of the classification model is a mature technology, and will not be described in detail herein. After the classification model is trained by using the extracted feature and the labeled training samples, the keyword screening model 322 is obtained.

The structure of the screening model establishing unit 312 is described in detail as above. Other component units of the apparatus 300 are described in detail in the following, and the component units are responsible for screening superior promotion keywords 320 based on the established keyword screening model 322. Specific descriptions are made as follows.

First, the keyword selection unit 306 selects candidate promotion keywords 324. In the example embodiment of the present disclosure, the candidate promotion keywords 324 may be obtained from two sources: search keywords of a merchant website and/or expansion words of promotion keywords that have been placed into.

The search keywords of the merchant website are keywords used by users for searching at the merchant website, and the keywords reflect, to a certain degree, the degree of interest of the users in the services or commodities provided by the merchant. By selecting candidate promotion keywords from these search keywords, the probability of bring in a conversion effect for the merchant is high. The search keywords of the users used internally at the merchant website within a certain period of time and conversion effect data of the keywords in the merchant website may be obtained from search logs of the website. The conversion effect data may include, for example, a search volume of the search keywords, and a page view, a click rate, a trade volume and the like caused by the search keywords. Search keywords having poor website conversion effects may be excluded by setting a threshold for the conversion effect data, while the remaining search keywords are used as candidate promotion keywords 324. Alternatively, search keywords having good website conversion effects are selected by setting a threshold for conversion effect data, and the selected search keywords are used as candidate promotion keywords 324.

For the promotion keywords that have been placed into the search engine, promotion keywords having good effects in the promotion keywords that have been placed into the search engine may be expanded by using an expansion tool. The obtained expansion words are added to the candidate promotion keywords. The keywords expanded by the word expansion tool are mainly synonyms or translated words. The synonym is easy to understand, and the translated word refers to a corresponding expression of a word in another commonly used language, for example, a common translated word of the brand “ [symbol] ” in Chinese is “apple” in English.

Then, the feature extraction unit 308 extracts features of the candidate promotion keywords 324. The features are consistent with the features extracted by the feature extraction sub-unit 3126 from the training samples 318 during the establishment of a keyword screening model 322. If the feature extraction sub-unit 3126 extracts the bid features, since the candidate promotion keywords 324 may not be placed into the search engine yet, there may not be bid features and the feature extraction unit 308 may construct bid features for the candidate promotion keywords 324 between the lowest bid and the highest bid according to a preset bid interval respectively.

Next, the keyword screening unit 310 uses the features of each of the candidate promotion keywords 324 as input data of the pre-established keyword screening model 322, and obtains the superior promotion keywords 320 according to a prediction result of the keyword screening model 322. In fact, the prediction process is a classification process of the classification model. The candidate promotion keywords 324 are at least classified into superior promotion keywords 320 and inferior promotion keywords (not shown in FIG. 3), and may also include medium promotion keywords (not shown in FIG. 3). For example, the number of classification results depends on the number of labeling results when labeling the training samples during the establishment of the keyword screening model.

Further, the bid price suggesting unit 314 may determine suggested bid prices of the superior promotion keywords 320. For example, the bid features of the superior promotion keywords 320 predicted by the keyword screening model are combined, and the highest bids are used as the suggested bid prices of the superior promotion keywords 320. If the features extracted from the keyword screening model 322 do not include the bid features, the suggested bid prices may be determined according to the operation experience or according to the effect data of the superior promotion keywords.

In order to further optimize the obtained superior promotion keywords 320, the keyword filtering unit 316 may perform at least one of the following filtering processing on the superior promotion keywords 320 obtained by the keyword screening unit 310:

Promotion keywords that have been placed into the search engine are removed from the obtained superior promotion keywords; and

Illegal keywords are removed from the obtained superior promotion keywords according to a prohibited word black list of a merchant website and/or a prohibited word black list of a search engine.

As shown from the above descriptions, the methods and apparatuses provided by the present disclosure have the following advantages:

1) The present disclosure, after the features of the candidate promotion keywords are extracted, predicts the superior promotion keywords by using the trained keyword screening model instead of the conventional screening mode that merely relies on a fixed threshold, and is capable of predicting a keyword that has no effect yet in the promotion system as well, thereby improving the accuracy and recall rate of the screening of superior promotion keywords and providing more correct and objective reference for the merchant to select the promotion keywords placed into the search engine.

2) The text features are introduced into the keyword screening model, which enriches the factors considered in the screening of the superior keywords, and improves the accuracy of screening the superior promotion keywords.

3) The influence of bid prices on placement effects of the promotion keywords is taken into consideration, and the bid features are introduced in the keyword screening model, such that the superior promotion keywords that are determined incorrectly due to unreasonable bids may be recalled effectively, thereby improving the accuracy and recall rate of screening the superior promotion keywords.

4) According to the bid features introduced in the keyword screening model, the obtained superior promotion keywords may obtain reasonable bid prices, thereby reducing budget waste of the merchant.

In the example embodiments of the present disclosure, it should be understood that the disclosed apparatuses and methods may be implemented through other modes. For example, the apparatus embodiment described above is merely exemplary. For instance, the division of the units may be a division of logic functions, and other division modes may also be used during actual implementation.

The units described as separate parts may or may not be physically separate, and the parts displayed as units may or may not be physical units as well. The units may be located in one position, or may be distributed among a plurality of network units. A part or all of the units may be selected according to actual needs to achieve the objectives of the solutions of the example embodiments.

In addition, the functional units in the example embodiments of the present disclosure may be integrated into one processing unit, or each of the units may exist alone physically, or two or more units are integrated into one unit. The integrated unit may be implemented in a form of hardware, or may be implemented in a form of hardware plus software functional unit.

The integrated unit implemented in the form of a software functional unit may be stored in a computer-readable medium. The software product is stored in such storage medium and includes computer-executable instructions that cause a computer device (which may be a personal computer, a server, or a network device) or a processor to perform all or a part of the steps of the methods described in the embodiments of the present disclosure. The foregoing storage medium includes any medium that may store program code, such as a USB flash drive, a removable hard disk, a Read-Only Memory (ROM), a Random Access Memory (RAM), a magnetic disk, or an optical disc.

The above descriptions are merely preferred embodiments of the present disclosure, and are not intended to limit the present disclosure. Any modification, equivalent replacement, improvement or the like made without departing from the spirit and principle of the present disclosure should all belong to the scope of the present disclosure

What is claimed is:

1. A method, comprising:
selecting one or more candidate promotion keywords;
extracting one or more features of the candidate promotion keywords;
using the one or more features of the candidate promotion keywords as input data of a pre-established keyword screening model; and
obtaining one or more superior promotion keywords according to a prediction result of the keyword screening model.

2. The method of claim 1, wherein the selecting the candidate promotion keywords comprises:
selecting the candidate promotion keywords by using a search keyword of a merchant website or an expansion word of a promotion keyword that has been placed into a search engine.

3. The method of claim 1, wherein the features comprise a search engine feature, the search engine feature comprising a search volume or popular rate information of a respective candidate promotion keyword in the search engine.

4. The method of claim 1, wherein the features comprise an effect feature of non-directed traffic, the effect feature of non-directed traffic comprising a search volume, a page view, a click rate, or a trade volume of a respective candidate promotion keyword at a merchant web site.

5. The method of claim 1, wherein the features comprise a text feature, the text feature comprising a word feature, a semantic feature, or an industry feature of a respective candidate promotion keyword,
wherein:
the word feature comprises at least one of a smallest word segmentation unit, a quantity of smallest word segmentation units, and a character length included in the respective candidate promotion keyword;
the semantic feature comprises at least one of a head word, a product word, and a brand word included in the respective candidate promotion keyword; and
the industry feature comprises an industry category to which the respective candidate promotion keyword belongs.

6. The method of claim 1, wherein:
the one or more features comprises a bid feature; and
the extracting one or more features of the candidate promotion keywords comprises constructing the bid feature of a respective candidate promotion keyword according to a preset bid interval between a lowest bid and a highest bid to the respective candidate promotion keyword.

7. The method of claim 6, wherein the method further comprises determining a respective suggested bid price of a respective superior promotion keyword.

8. The method of claim 7, wherein the determining the respective suggested bid price of the respective superior promotion keyword comprises:
combining the bid feature of the respective superior promotion keyword; and
using a highest bid as the respective suggested bid price of the respective superior promotion keyword.

9. The method of claim 1, further comprising performing one or more filtering to the obtained superior promotion keywords, the filtering comprising at least one of:
removing, from the obtained superior promotion keywords, one or more promotion keywords that have been placed into a search engine; and
removing illegal keywords from the obtained superior promotion keywords according to a prohibited word black list of a merchant website or a prohibited word black list of the search engine.

10. The method of claim 1, further comprising establishing the keyword screening model, the establishing comprising:
using data of one or more promotion keywords that have been placed into a search engine as training samples;
determining, by using the data of the promotion keywords, return on investment for each of the promotion keywords;
labeling the training samples according to the return on investment for the each of the promotion keywords;
extracting the features of each of the promotion keywords in the training samples, the features being consistent with the extracted features of the candidate promotion keywords; and
training a classification model by using the extracted features and the labeled training samples to obtain the keyword screening model.

11. The method of claim 10, wherein the determining, by using the data of the promotion keywords, return on investment for the each of the promotion keywords comprises at least one of the following:
using a ratio of a traffic introduced into the merchant website by a respective promotion keyword through the search engine to a cost of the investment of the merchant for the respective promotion keyword as the return on investment for the respective promotion keyword;
using a ratio of advertising income introduced into the merchant by the respective promotion keyword through the search engine to a cost of the investment of the merchant for the respective promotion keyword as the return on investment for the respective promotion keyword; and
using a ratio of a trade volume introduced into the merchant by the respective promotion keyword through the search engine to a cost of the investment of the merchant for the respective promotion keyword as the return on investment for the respective promotion keyword.

12. The method of claim 10, wherein the labeling the training samples according to the return on investment for the each of the promotion keywords comprises:
in response to determining that the return on investment for a respective promotion keyword is greater than or equal to a preset first threshold, labeling the respective promotion keyword as a superior promotion keyword; and
in response to determining that the return on investment for the respective promotion keyword is less than a preset second threshold, labeling the respective promotion keyword as an inferior promotion keyword, the first threshold being greater than or equal to the second threshold.

13. The method of claim 12, wherein in response to determining that the first threshold is greater than the second threshold, the labeling the training samples according to the return on investment for the each of the promotion keywords further comprises:
in response to determining the return on investment for the respective promotion keyword is greater than or equal to the second threshold and is less than the first threshold, labeling the respective promotion keyword as a medium promotion keyword.

14. An apparatus, comprising:
a keyword selection unit that selects one or more candidate promotion keywords;
a feature extraction unit that extracts one or more features of the candidate promotion keywords; and
a keyword screening unit that uses the one or more features of the candidate promotion keywords as input data of a pre-established keyword screening model and obtains one or more superior promotion keywords according to a prediction result of the keyword screening model.

15. The apparatus of claim 14, wherein the keyword selection unit further selects the candidate promotion keywords by using a search keyword of a merchant website or an expansion word of a promotion keyword that has been placed into a search engine.

16. The apparatus of claim 14, wherein
the one or more features comprises a bid feature; and
the feature extraction unit extracts one or more features of the candidate promotion keywords comprises constructing the bid feature of a respective candidate promotion keyword according to a preset bid interval between a lowest bid and a highest bid to the respective candidate promotion keyword.

17. The apparatus of claim 14, wherein the apparatus further comprises a bid price suggesting unit that combines the bid feature of a respective superior promotion keyword;
and using a highest bid as a respective suggested bid price of the respective superior promotion keyword.

18. The apparatus of claim 14, wherein the apparatus further comprises a keyword filtering unit that performs one or more filtering to the obtained superior promotion keywords, the filtering including at least one of:
removing, from the obtained superior promotion keywords, one or more promotion keywords that have been placed into a search engine; and
removing illegal keywords from the obtained superior promotion keywords according to a prohibited word black list of a merchant website or a prohibited word black list of the search engine.

19. The apparatus of any of claims 14, wherein the apparatus further comprises a screening model establishing unit that establishes the keyword screening model, the screening model establishing unit including:
a sample determination sub-unit that uses data of one or more promotion keywords that have been placed into a search engine as training samples;
a sample labeling sub-unit that determines, by using the data of the promotion keywords, return on investment for each of the promotion keywords and labels the training samples according to the return on investment for the each of the promotion keywords;
a feature extraction sub-unit that extracts the features of each of the promotion keywords in the training samples, the features being consistent with the extracted features of the candidate promotion keywords; and
a model training sub-unit that trains a classification model by using the extracted features and the labeled training samples to obtain the keyword screening model.

20. One or more memories having stored thereon computer-readable instructions executable by one or more processors to perform operations comprising:
selecting one or more candidate promotion keywords;
extracting one or more features of the candidate promotion keywords;
using the one or more features of the candidate promotion keywords as input data of a pre-established keyword screening model; and
obtaining one or more superior promotion keywords according to a prediction result of the keyword screening model.
